(19) United States
(12) Patent Application Publication
(10) Pub. No.: US 2006/0284481 A1
(43) Pub. Date: Dec. 21, 2006

(54) Brake pedal control apparatus

(76) Inventor: Shinichi Yone, Saitama (JP)

Correspondence Address: CARRIER BLACKMAN AND ASSOCIATES, 24101 NOVI ROAD, SUITE 100, NOVI, MI, 48375, US

(21) Appl. No.: 10/557,038

(22) PCT Filed: Aug. 20, 2004
(86) PCT No.: PCT/JP04/12328

§ 371 Date: Nov. 16, 2005

(30) Foreign Application Priority Data
Aug. 28, 2003 (JP) 2003-209375

(51) Int. Cl. B60T 8/34

(52) U.S. Cl. 303/155; 303/113.4; 340/435

(57) ABSTRACT

A brake pedal control apparatus includes a pedal position changing device (17) for changing an initial position of a brake pedal (ii), an object sensor (20) for detecting an object in a traveling direction of the vehicle, a vehicle condition sensor (19) for detecting a traveling condition of the vehicle, and a control unit (15) for, on the basis of outputs from the object sensor (20) and the vehicle condition sensor (19), setting a target initial position displaced forward from the initial position of the brake pedal (11) and controlling operation of the pedal position changing device (17) so that the initial position of the brake pedal (11) coincides with the target initial position.

### TECHNICAL FIELD

The present invention relates to a brake pedal control apparatus for automatically changing the initial position of a brake pedal in a direction to reduce a free travel time of the brake pedal to thereby improve a response to an object existing ahead of the own vehicle.

### BACKGROUND ART

In an automotive vehicle, operating levers or pedals form a sort of input devices adapted to be manipulated by the driver. When such input devices are operated, the driver feels on its hand or foot a certain amount of reaction force, which is produced in general by a kinetic action of a mechanism. In another case, such reaction force is produced virtually and positively in accordance with operation of an operation lever or pedal as if the operation lever or pedal serves as an output device. The device of this kind is called “haptic device” and an example haptic device is disclosed in Japanese Patent Laid-Open Publication No. JP-A-2001-105926.

The disclosed haptic device is used as an operating device for vehicles and includes, as shown in FIG. 5 hereof, a foot pedal 101 operatively connected via an actuating rod 102 to a stroke simulator 103, and a stroke sensor 104 associated with the actuating rod 102. With this arrangement, the stroke simulator 103 produces a reaction force acting on the foot pedal 101 in accordance with the stroke of the foot pedal 101. The stroke simulator 103 is connected via an electric control unit (ECU) 105 to a throttle device 106. The ECU 105 supplies a command signal to the throttle device 106 so that the throttle opening varies with the pedal stroke.

For rapid acceleration of the vehicle, the foot pedal 101 is abruptly pressed down fully to cause kickdown of an automatic transmission. To this end, the operating device has a kickdown switch 109 disposed behind the foot pedal 101. When the foot pedal 101 is depressed to a predetermined position, the kickdown switch is turned on or activated whereupon kickdown occurs in the automatic transmission.

Another example of conventional pedal adjusting apparatus is disclosed in Japanese Patent Publication JP-B2-2734213. The disclosed apparatus includes a pedal assembly or unit composed of a plurality of pedals (accelerator pedal, brake pedal and so on), a pedal actuator operable in response to depression of at least one pedal to change the initial position of the other pedal toward a pressing or forward direction, a pedal stroke sensor for detecting the amount of pedal stroke in the pressing direction, and a controller for controlling operation of the pedal actuator in such a manner that the initial position of the other pedal can be changed in accordance with the detected pedal stroke.

The operating device shown in JP-A-2001-105926 has no means or arrangement that enables change of the initial position of the foot pedal 101 (FIG. 5). Accordingly, assuming that the foot pedal 101 forms a brake pedal, the initial released position of the foot pedal is always constant and remains unchanged even in case of an emergency. It is, therefore, impossible to reduce a free travel time (also called “free running time”) of the foot pedal 101 and facilitate smooth foot transfer from the accelerator pedal to the foot pedal.

In the pedal adjusting apparatus shown in JP-B2-2734213, the stroke of the accelerator pedal is detected to change the initial position of the brake pedal. The change in the initial position of the brake pedal is achieved for the purpose of adjusting respective initial positions of the plural different pedals in accordance with physical constitution of the driver while the positional relationship in the pressing direction between the pedals is kept constant. To this end, the amount of displacement of the initial position of the brake pedal that is achieved upon detection of the stroke of the accelerator pedal is solely dependent on the stroke of the accelerator. There is no ideal disclosed in the latter-mentioned Japanese publication that the initial position of the brake pedal is adjustably changed in accordance with a traveling condition including likelihood of collision of the vehicle with an object.

It is, therefore, an object of the present invention to provide a brake pedal control apparatus which is capable of changing the initial position of a brake pedal in a forward or braking direction depending on a traveling condition of the vehicle, thereby reducing a free travel time of the brake pedal, increasing a response time at braking, and facilitating smooth foot transfer from the accelerator pedal to the brake pedal.

### DISCLOSURE OF THE INVENTION

According to the present invention, there is provided a brake pedal control apparatus for a vehicle comprising: a brake pedal pivotally mounted on a body of the vehicle; a pedal position changing device for changing an initial position of the brake pedal; an object sensor for detecting an object in a traveling direction of the vehicle; a vehicle condition sensor for detecting a traveling condition of the vehicle; and a control unit for, on the basis of an output from the object sensor and an output from the vehicle condition sensor, setting a target initial position displaced forward from the initial position of the brake pedal and controlling operation of the pedal position changing device so that the initial position of the brake pedal coincides with the target initial position.

With the brake pedal control apparatus thus arranged, it is possible to automatically change the initial position of the brake pedal in a forward or braking direction in case of an emergency to reduce a free travel time (also called “free running time”) of the brake pedal before a braking effort or force to retard the vehicle is produced. The automatic change of initial position also facilitates smooth foot change from an accelerator pedal to the brake pedal in an emergency.

In one preferred form of the invention, the vehicle condition sensor comprises a vehicle velocity sensor for detecting a velocity of the vehicle, the object sensor comprises a distance sensor for detecting a relative distance between the vehicle and the object, and the control unit, when likelihood of collision of the vehicle with the object determined on the basis of the vehicle velocity detected by the vehicle velocity sensor and the relative distance detected by the distance sensor is higher than a first reference value, sets the target initial position such that the brake pedal, as it is in the target initial position, produces a braking force to retard the motion of the vehicle is produced.

It is preferable that when the likelihood of collision of the vehicle with the object determined on the basis of the vehicle velocity detected by the vehicle velocity sensor and the relative distance detected by the distance sensor is less than or equal to the first reference value and higher than a second reference value smaller than the first reference value, the control units sets the target initial position such that the brake pedal, as it is in the target initial position displaced forward from the initial position of the brake pedal, does not produce a braking force to retard the motion of the vehicle.

By thus setting the target initial position of the brake pedal, the brake pedal is automatically placed in one of two or more alternative initial positions so determined as to reduce the free travel time to an extent best suited for the underlying conditions determined on the basis of the likelihood of collision of the vehicle with the object.

### BRIEF DESCRIPTION OF THE DRAWINGS

FIG. 1 is a block diagram showing the general configuration of a brake pedal control apparatus according to an embodiment of the present invention;

FIG. 2 is a block diagram showing the configuration of a pedal reaction control section of the brake pedal control apparatus;

FIG. 3 is a block diagram showing the configuration of a target pedal initial position determining section of the brake pedal control apparatus;

FIG. 4 is a flowchart showing a sequence of control operations achieved in accordance with a pedal position changing program; and

FIG. 5 is a diagrammatical view showing the arrangement of a conventional brake pedal unit for a vehicle.

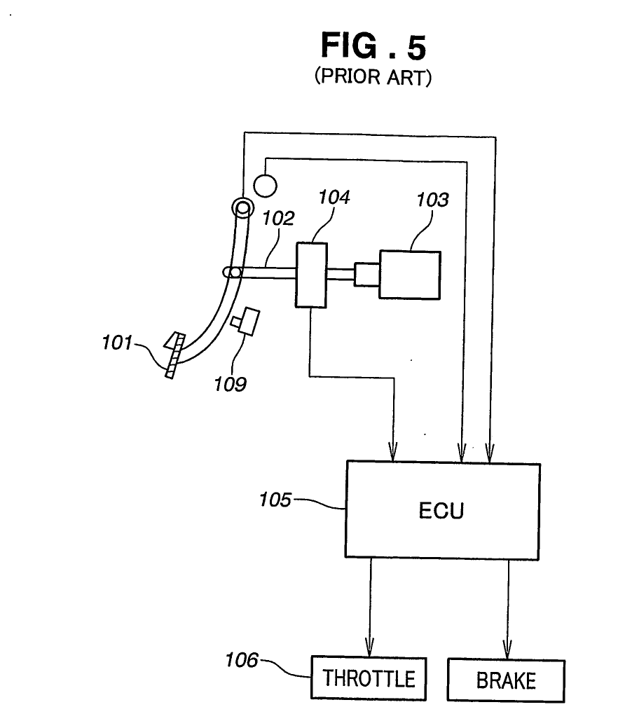

### BEST MODE FOR CARRYING OUT THE INVENTION

One preferred embodiment of the present invention will be described below in greater detail with reference to the accompanying sheets of drawings.

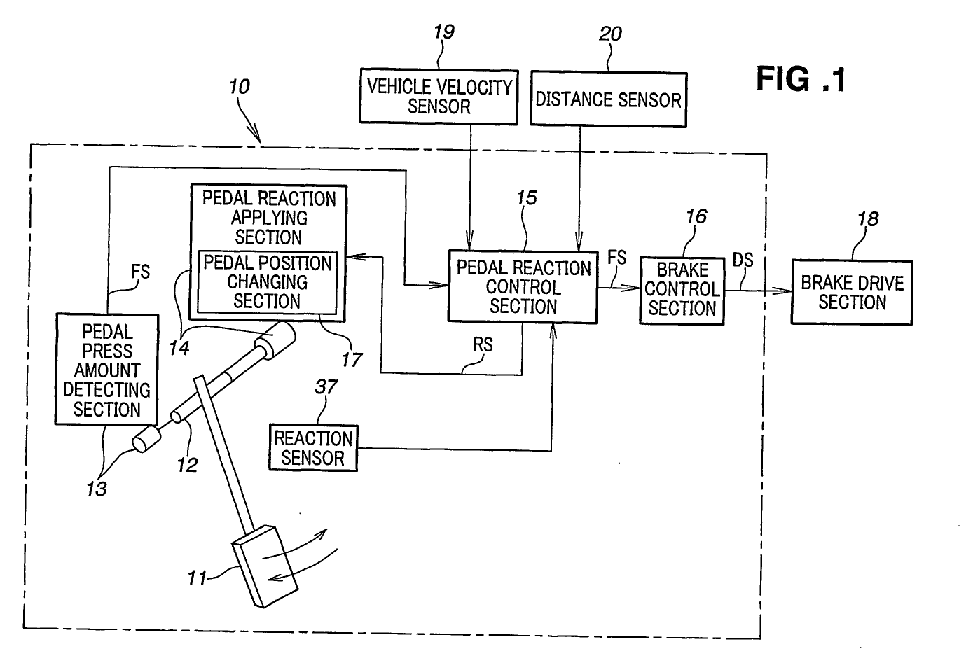

FIG. 1 shows in block diagram the general configuration of a brake pedal control apparatus according to an embodiment of the present invention. The brake pedal control apparatus 10 generally comprises a brake pedal 11 pivotally mounted on a body of a vehicle, a pedal position detecting section 13 connected to one end of a pedal shaft (pivot shaft) 12 of the brake pedal 11 for detecting a position of the brake pedal 11, a pedal reaction applying section 14 connected to the other end of the pedal shaft 12 for producing a reaction force (acting on the brake pedal 11 in a direction opposite to the direction of a pedal pressure on the brake pedal 11) in accordance with a pedal position signal FS from the pedal position detecting section 13, a pedal reaction control section 15 for controlling the reaction force on the brake pedal 11 by supplying a reaction signal RS to the pedal reaction applying section 14 on the basis of the pedal position signal FS, and a brake control section 16 receiving the pedal position signal FS via the pedal reaction control section 15. The pedal reaction applying section 14 includes a pedal position changing section or device 17. The brake pedal 11 is normally disposed in a released position and has a pedal travel involving free travel (also called “free running” or “play”). The released position of the brake pedal 11 under normal conditions is referred to as “original initial position”. As is well known, the pedal travel is the total stroke of the brake pedal 11, and the free travel is the amount of pedal movement before the brake mechanism is actuated.

The brake control section 16 sends a drive signal DS to a brake drive section 18 on the basis of the pedal position signal FS whereupon braking of the vehicle is controlled.

The pedal position detecting section 13 comprises a rotational angle sensor for detecting a rotational angle (or an amount of angular displacement) of the pedal shaft 12. The amount of angular displacement of the brake pedal 11 corresponds to the amount of pedal press and, hence, the rotational angle sensor 13 also serves as a press amount sensor, which is capable of detecting the amount of pedal press or stroke in a forward or braking direction).

The pedal reaction applying section 14 includes the pedal position changing device 17, as previously described, for the purpose of changing an initial position of the brake pedal 11 on the basis of a signal from a vehicle condition sensor (for example, a vehicle velocity sensor) 19 and a signal from an object sensor (for example, a distance sensor) 20. The pedal position changing device 17 comprises an electric motor provided with an output shaft thereof connected to the pedal shaft 12.

The pedal reaction control section 15, on the basis of the pedal position signal FS, controls reaction force values (especially a maximum reaction force value) and a particular pressed position of the brake pedal 11 where reaction force on brake pedal 11 starts to occur. The pedal reaction control section 15 also controls operation of the pedal position chanting device (electric motor) 17 on the basis of the signal from the vehicle condition sensor (vehicle velocity sensor) 19 and the signal from the object sensor (distance sensor) 20, so that the initial position of the brake pedal 11 can be changed in a manner as described later.

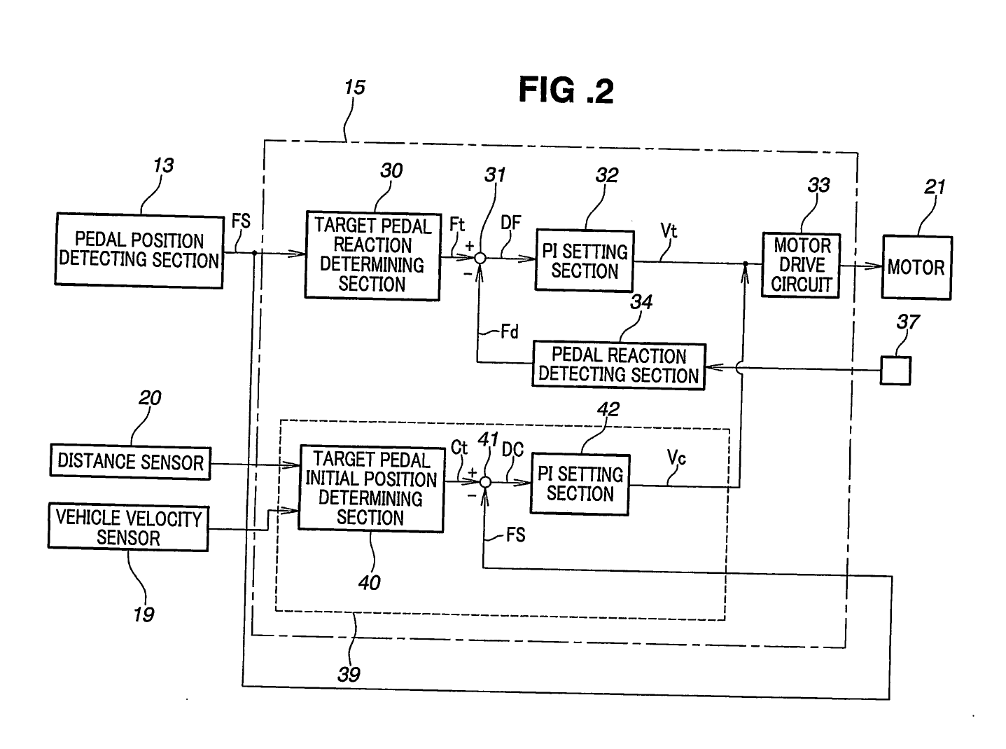

FIG. 2 shows in block diagram the configuration of the pedal reaction control section 15. The pedal reaction control section 15 is constructed to control operation of a motor 21 on the basis of the pedal position signal FS supplied from the pedal position detecting section 13. The motor 21 forms an actuator of the pedal position changing device 17. The pedal reaction control section 15 generally comprises a target pedal reaction determining section 30, a deviation calculating section 31, a PI setting section 32, a motor drive circuit 33, a pedal reaction detecting section 34, and a pedal position control section 39. The pedal position control section 39 receives, as inputs, a signal from the object sensor (distance sensor) 20 and a signal from the vehicle condition sensor (vehicle velocity sensor) 19 and operates to set a target pedal initial position for controlling operation of the pedal position changing device 17 (FIG. 1).

The target pedal reaction determining section 30 calculates a target pedal reaction force Ft on the basis of the pedal position signal FS and outputs the calculated target pedal reaction force to the deviation calculating section 31. The deviation calculating section 31 subtracts from the target pedal reaction force Ft a detected pedal reaction force value Fd from the pedal reaction detecting section 34, thus calculating out a deviation or offset DF between the target pedal reaction force Ft and the detected pedal reaction force value Fd. The deviation DF thus calculated is output from the deviation calculating section 31 to the PI setting section 32. The PI setting section 32 performs calculation using the deviation DF to compute a target voltage Vt, which will make the detected pedal reaction force value Fd coincident with or equal to the target pedal reaction force Ft. A target voltage signal representing the computed target voltage Vt is output from the PI setting section 32 to the motor drive circuit 33. The motor drive circuit 33 drives the motor 21 at the target voltage Vt. The pedal reaction detecting section 34, on the basis of a signal from a reaction sensor 37 associated with the motor 21, detects a pedal reaction force Fd and outputs a value representing the detected pedal reaction force to the deviation calculation section 31.

The pedal position control section 39 is constructed to drive the motor 21 so that the pedal position changing device 17 performs necessary operation to change the initial position of the brake pedal 11 on the basis of the outputs from the vehicle condition sensor (vehicle velocity sensor) 19 and object sensor (distance sensor) 20. To this end, the pedal position control section 39 comprises a target pedal initial position determining section 40, a deviation calculating section 41, and a PI setting section 42.

The target pedal initial position determining section 40 determines a target pedal initial position Ct on the basis of a vehicle velocity signal from the vehicle velocity sensor 19 and a relative distance signal from the distance sensor 20 and outputs the determined target pedal initial position Ct to the deviation calculating section 41. The deviation calculating section 41 is provided to perform feedback control with respect to the target pedal initial position Ct. To this end, the deviation calculating section 41 subtracts from the target pedal initial position Ct a detected pedal position FS from the pedal position detecting section 13 to thereby calculate a deviation or offset DC of the detected pedal initial position FS from the target pedal initial position Ct. The calculated deviation DC is output from the deviation calculating section 41 to the PI setting section 42. The PI setting section 42 performs calculation using the deviation DC to compute a target voltage Vc, which will make the detected pedal position FS coincident with or equal to the target pedal initial position Ct. The target voltage Vc is output from the IP setting section 42 to the motor drive circuit 33.

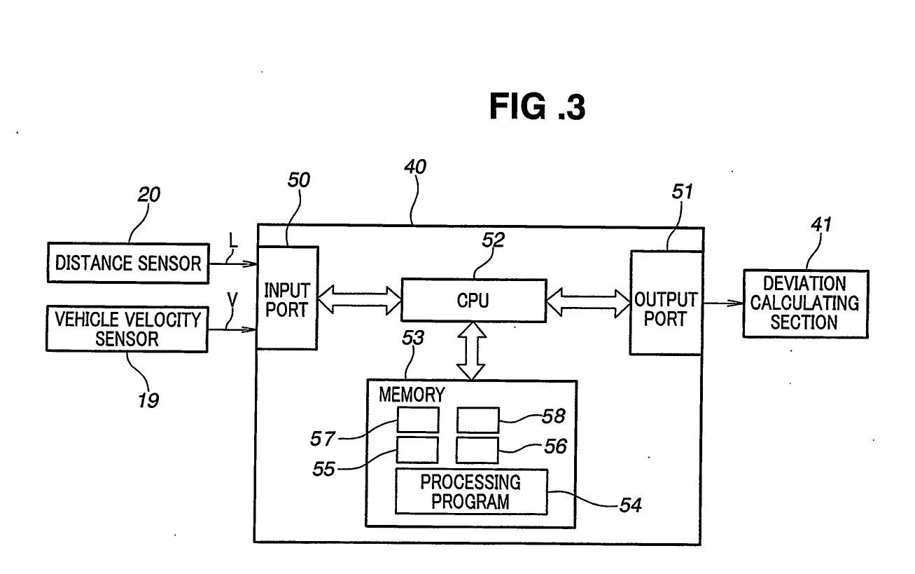

FIG. 3 shows in block diagram the configuration of the target pedal initial position determining section 40. As shown in this figure, the target pedal initial position determining section 40 comprises an input port 50, an output port 51, a CPU (Central Processing Unit) 52, and a memory 53. The memory 53 has a first storage area 54 in which is stored in advance a pedal initial position adjusting program so prepared as to determine the aforesaid target pedal initial position on the basis of the vehicle velocity and the relative distance between the vehicle and an object in font of the vehicle. The memory 53 also has a second storage area 55 in which a first reference value C1 of likelihood of collision is stored in advance, and a third storage area 56 in which a second reference value C2 of likelihood of collision is stored in advance. In a fourth storage area 57 of the memory 53, a first pedal initial position P1 is stored in advance. The first pedal initial position PI is determined such that when the brake pedal 11 is disposed in this first pedal initial position P, it actuates the brake drive section 18 (FIG. 1) to generate a braking force. Similarly, in a fifth storage area 58 of the memory 53, a second pedal initial position P2 is stored in advance. The second pedal initial position P2 is determined such that the brake pedal 11, as it is in the second pedal initial position P2, does not actuate the brake drive section 18 to generate a braking force but is still located forward of the original initial position of the brake pedal 11. Stated in other words, the brake pedal 11, as it is in the second pedal initial position P2, is disposed in a position located within a range of free travel of the brake pedal 11.

The likelihood of collision of the vehicle with an object including a vehicle) ahead of the vehicle may be expressed as a function of the vehicle velocity (V) detected by the vehicle velocity sensor (vehicle condition sensor) 19 and the relative distance (L) between the vehicle and the object detected by the distance sensor (object sensor) 20, such as C=V/L. With respect to the likelihood of collision, the first reference value C1 is set to represent a higher likelihood of collision than the second reference value C2 does. The first reference value C1 is determined such that when likelihood of collision calculated on the basis of the vehicle velocity (V) and the relative distance (L) is higher than the first reference value C1, the initial position of the brake pedal 11 is changed or shifted to the first pedal initial position P1 where a braking force to retard the motion of the vehicle is produced. Similarly, the second reference values C2 is determined such that when the likelihood of collision obtained by calculation is lower than or equal to the first reference value C1 and but still higher than the second reference value C2, the initial position of the brake pedal 11 is changed or shifted to the second pedal initial position P2, which is displaced forward from the original initial position of the brake pedal 11 but does not produce a braking force to retard the motion of the vehicle.

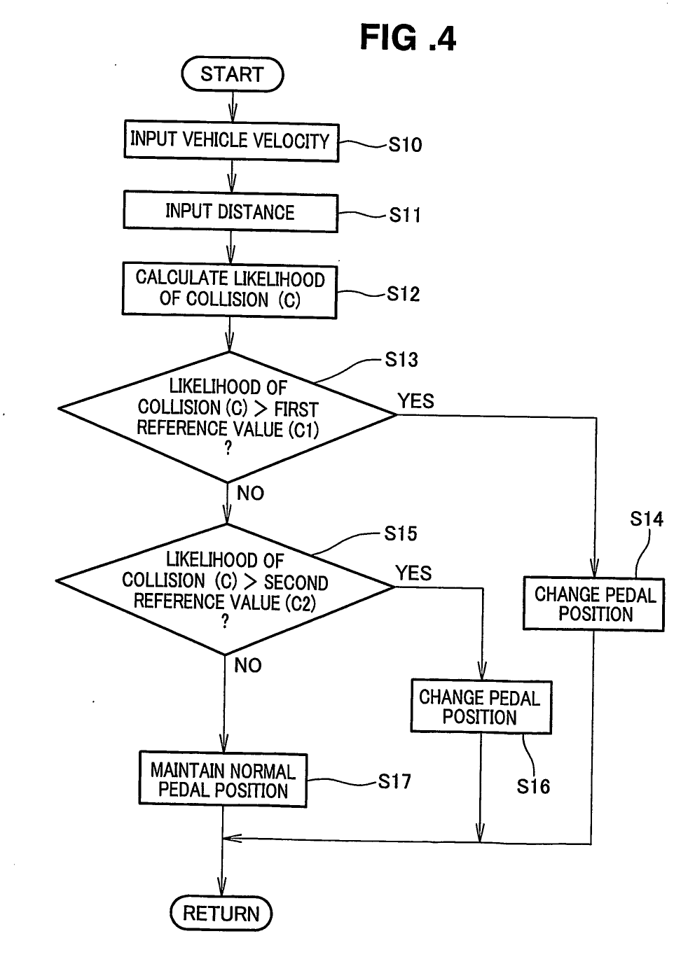

Referring next to the flowchart shown in FIG. 4, description will be given of a control procedure achieved by the CPU 52 (FIG. 3) in accordance with the pedal initial position adjusting program stored in the memory 53 of the target pedal initial position determining section 40.

The control procedure begins when the ignition switch (not shown) is turned on. At a first step S10, a vehicle velocity signal V (FIG. 3) from the vehicle velocity sensor 19 is input through the input port into the CPU 52. Then, a step S11 reads a relative distance signal L from the distance sensor 20 through the input port 50 into the CPU 52. Subsequently, a step S12 calculates likelihood of collision C of the vehicle with an object (including a vehicle) in front of the vehicle on the basis of the vehicle velocity V and the relative distance L. In this instance, a relational expression C=V/L is used.

Then a step S13 compares the calculated likelihood of collision C with the first reference value C1 that is retrieved from the storage area 55 of the memory 53. If C>C1, the control procedure branches off into a step S14, which retrieves the first pedal initial position P1 from the storage area 57 of the memory 53 and outputs a corresponding command signal as a target pedal initial position signal Ct. In accordance with the target pedal initial position signal Ct, the electric motor 21 (FIG. 2) of the pedal position changing section or device 17 is controlled in operation so that the initial position of the brake pedal 11 is changed to the first pedal initial position P1 where a braking force to retard the motion of the vehicle is produced. Thereafter, the control procedure returns to the step S10.

Alternatively, when the comparison made at the step S13 indicates C<C1, the control procedure goes on to a step S15 where another comparison is made between the calculated likelihood of collision C and the second reference value C2 retrieved from the storage area 56 of the memory 53. In this instance, if C>C2, the control procedure branches off into a step S16, which retrieves the second pedal initial position P2 from the storage area 58 of the memory 53 and outputs a corresponding command signal as a target pedal initial position signal Ct. In accordance with the target pedal initial position signal Ct, the electric motor 21 (FIG. 2) of the pedal position changing section or device 17 is controlled in operation so that the initial position of the brake pedal 11 is changed to the second pedal initial position P2, which is displaced forwardly from the original initial position but does not produce any braking force. The second pedal initial position is located within a range of free travel of the brake pedal 11. Thereafter, the control procedure returns to the step S10.

Alternatively, when the comparison at the step S15 represents C<C2, the control procedure goes on to a step S17 where no output signal is issued from the target pedal initial position determining section 40 (FIGS. 2 and 3) and the original initial position of the brake pedal 11 remains unchanged. Thereafter, the control procedure returns to the step S10.

As thus far explained, the initial position of the brake pedal 11 can be changed continuously between three alternative positions in accordance with likelihood of collision of the vehicle with an object that is determined by calculation on the basis of a traveling condition, such as velocity, of the vehicle and a relative distance between the vehicle and the object ahead of the vehicle. Sine two of the alternative initial positions except the original initial position are displaced from the original initial position in a forward or braking direction, it is possible to reduce the free travel time (also called “free running time”) of the brake pedal to an extent best suited for the underlying degree of likelihood of collision. Such automatic change of pedal initial position also facilitates smooth foot transfer from the accelerator pedal to the brake pedal in case of an emergency. It will be appreciated that the number of initial positions that is available for the brake pedal 11 is not limited to three as in the illustrated embodiment but may four or more where appropriate.

### INDUSTRIAL APPLICABILITY

With the arrangements so far described, the present invention can be used advantageously as a brake pedal control apparatus for a vehicle, which is capable of changing the initial position of a brake pedal in a forward or braking direction to reduce a free travel time of the brake pedal depending on likelihood of collision of the vehicle with an object ahead of the vehicle.

1. A brake pedal control apparatus for a vehicle comprising:
a brake pedal pivotally mounted on a body of the vehicle;
a pedal position changing device for changing an initial position of the brake pedal;
an object sensor for detecting an object in a traveling direction of the vehicle;
a vehicle condition sensor for detecting a traveling condition of the vehicle; and
a control unit for, on the basis of an output from the object sensor and an output from the vehicle condition sensor, setting a target initial position displaced forward from the initial position of the brake pedal and controlling operation of the pedal position changing device so that the initial position of the brake pedal coincides with the target initial position.

2. The brake pedal control apparatus as claimed in claim 1, wherein the vehicle condition sensor comprises a vehicle velocity sensor for detecting a velocity of the vehicle, the object sensor comprises a distance sensor for detecting a relative distance between the vehicle and the object, and the control unit, when likelihood of collision of the vehicle with the object determined on the basis of the vehicle velocity detected by the vehicle velocity sensor and the relative distance detected by the distance sensor is higher than a first reference value, sets the target initial position such that the brake pedal, as it is in the target initial position, produces a braking force to retard the motion of the vehicle.

3. The brake pedal control apparatus as claimed in claim 2, wherein when the likelihood of collision of the vehicle with the object determined on the basis of the vehicle velocity detected by the vehicle velocity sensor and the relative distance detected by the distance sensor is less than or equal to the first reference value and higher than a second reference value smaller than the first reference value, the control units sets the target initial position such that the brake pedal, as it is in the target initial position displaced forward from the initial position of the brake pedal, does not produce a braking force to retard the motion of the vehicle.
